(19) United States
(12) Patent Application Publication
(10) Pub. No.: US 2008/0197217 A1
(43) Pub. Date: Aug. 21, 2008

(54) Fog nozzle with abrasion resistance

(76) Inventor: Hsu Chih-Lung, (US)

Correspondence Address: Liberty PTO, P.O. Box 590, Taichung, 400, omitted

(21) Appl. No.: 11/707,909

(22) Filed: Feb. 20, 2007

(51) Int. Cl. B05B 1/02

(52) U.S. Cl. 239/591

(57) ABSTRACT

A fog nozzle with abrasion resistance is provided. The fog nozzle is disposed with a fluid throughway therein, and the fluid throughway is provided with a pusher therein. An embedded inner chamber is formed on one end of the fluid throughway. An abrasion resistant blockage with spray bores is provided and fixed within the embedded inner chamber. As a result, fluid entering the body of the nozzle pushes the pusher, and becomes fog when sprayed out from the spray bores of the abrasion resistant blockage.

The high resistance affect of the abrasion resistant blockage can reduce the abrasion of the spray bores; as a result, the diameter of the spray bores is less likely to become bigger, and thus the lifetime of the product can be increased.

### FIELD OF THE INVENTION

The present invention relates to a fog nozzle; in particular, the present invention relates to a fog nozzle assembled on the surface of the throughway in the fog forming system, such that the fluid being sprayed out becomes fog.

### BACKGROUND OF THE INVENTION

The conventional fog forming system can be installed indoor or outdoor. When fluid, such as water, is sprayed out from the nozzle of the throughway, it becomes foggy. The foggy fluid dissipated in the air can raise the humidity in the environment, or lower the temperature in the environment.

Refer to FIG. 1. The conventional nozzle structure includes a nozzle body 10, and a fluid throughway 12 is formed in an axial direction. One end of the fluid throughway 12 is an input end 14, while the other end is an output end 16. A pusher 18 is assembled in the fluid throughway 12 such that it can move freely between the input end 14 and the output end 16.

It is to be noted that, as the fluid continues to flow out from the output end 16, it causes abrasion at the opening of the output end 16, and thus the output end 16 becomes larger. Therefore, when the fluid is sprayed out, fog cannot be formed, or the fluid falls as water drops.

The problem that fluid is unable to form fog or that fluid becomes water drops can be solved by replacing the fog nozzle. However, it obviously increases the maintenance cost to replace the whole fog nozzle when other parts have not been worn.

### SUMMARY OF THE INVENTION

In view of the problem disclosed in the prior art that fog cannot be formed and that fluid becomes water drop after the fog nozzle is used for a long period of time, the present invention provides a novel structure that solves the above-mentioned problem.

One object of the present invention is to provide a fog nozzle with high abrasion resistance so as to prolong the time that the opening at the output end of the fog nozzle becomes larger, thereby increasing the lifetime of the fog nozzle.

In other words, the present invention provides a fog nozzle with abrasion resistance. The fog nozzle includes a nozzle body, an embedded inner chamber, a pusher, and an abrasion resistant blockage. The inside of the nozzle body is provided with a fluid throughway; the embedded inner chamber is formed at one end of the fluid throughway; the pusher is assembled inside the fluid throughway and can move freely; the abrasion resistant blockage is assembled in the embedded inner chamber, and a spray bore is opened in an axial direction on the abrasion resistant blockage to be connected to the fluid throughway.

Therefore, abrasion on the spray bore can be decreased by the high abrasion resistance of the abrasion resistant blockage so that the opening of the spray bore will not become too large in a short period of time. The problem mentioned in the prior art can thus be solved while the lifetime of the product can be increased.

### BRIEF DESCRIPTION OF THE DRAWING

FIG. 1 is a schematic view of a conventional fog nozzle structure;

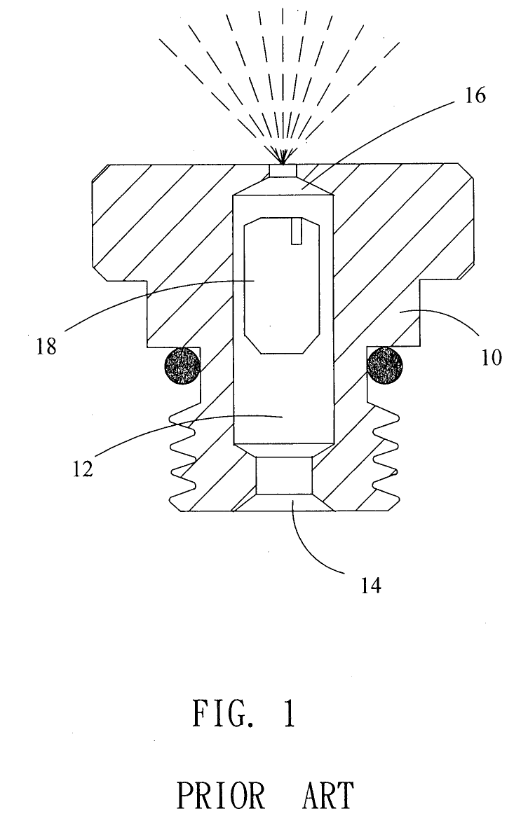

FIG. 2 is an exploded view of the present invention;

FIG. 3 is a schematic view of the structure of the present invention; and

FIG. 4 is a schematic view of the present invention in use.

### DETAILED DESCRIPTION OF THE EMBODIMENTS

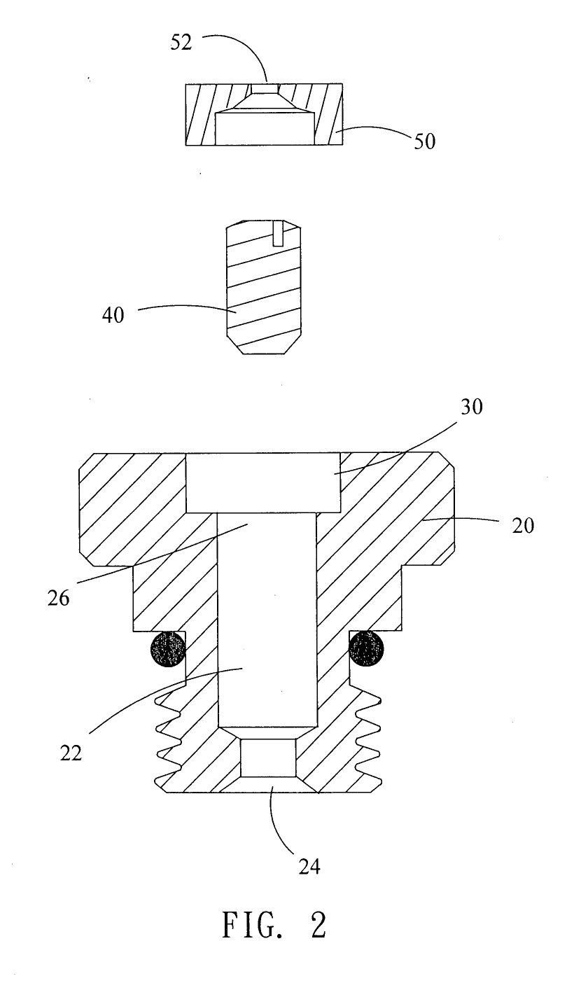

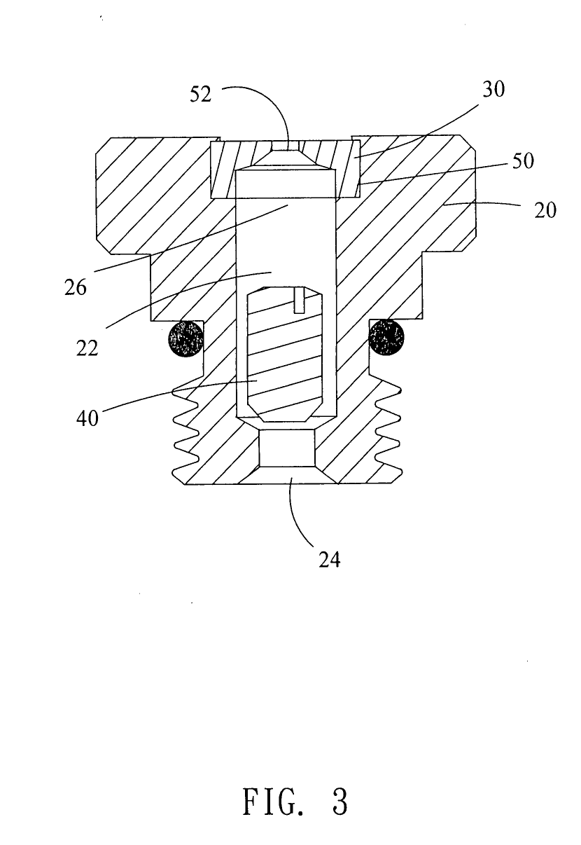

Refer to FIGS. 2 and 3. The fog nozzle of the present invention includes a nozzle body 20. A fluid throughway 22 is provided within the nozzle body 20. The fluid throughway 22 has two opposite ends, wherein one end is defined as an entry 25, while the other end is defined as an exit 26.

Additionally, an embedded inner chamber 30 is formed at one end of the fluid throughway 22 and adjacent to the exit 26. The embedded inner chamber 30 is extended from the exit 26 into the nozzle body 20. The diameter of the embedded inner chamber 30 is larger than that of the exit 26 so that the embedded inner chamber 30 can contain the abrasion resistant blockage 50.

A pusher 40 is assembled inside the fluid throughway 22. The pusher 40 can also move freely within the fluid throughway 22.

An abrasion resistant blockage 50 is assembled within the embedded inner chamber 30. In an axial direction of the abrasion resistant blockage 50 is provided with a spray bore 52 connecting to the fluid throughway 22; wherein, one end of the spray bore 52 is formed in circular hole, while the other end is formed in cone shape.

The above-mentioned abrasion resistant blockage 50 can be manufactured in ceramic material, glass material, tungsten steel material, or artificial gem material, and thus has high abrasion resistance.

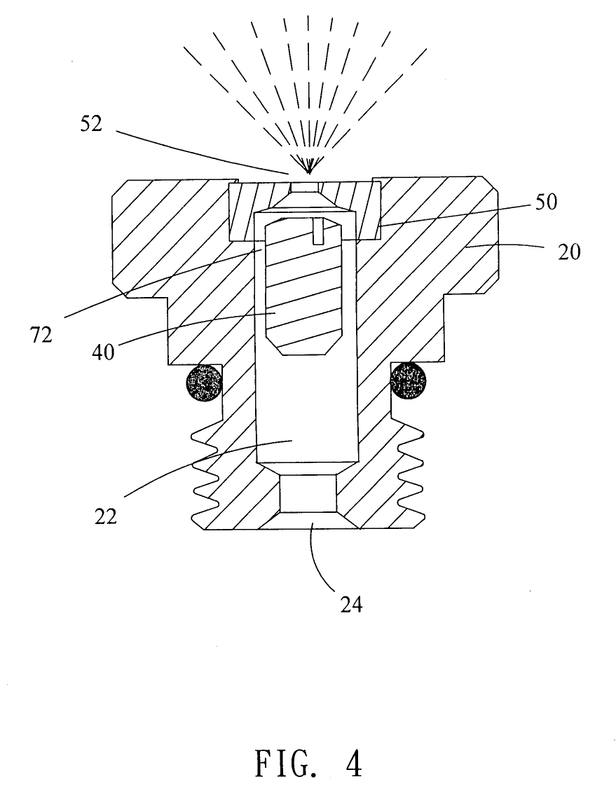

Refer to FIG. 4. When the fluid enters the nozzle body 20 from the entry 24, it will push the pusher 40. The fluid will pass through the gap 72 between the pusher 40 and the fluid throughway 22 and arrive at one end of the spray bore 52 of the abrasion resistant blockage 50. When the fluid is sprayed out from the spray bore 52 of the abrasion resistant blockage 50, fog is formed.

Because the abrasion resistant blockage 50 is manufactured with material high in abrasion resistance, the abrasion rate on the surface of the spray bore 52 is reduced when the fluid passes through the spray bore 52. Therefore, the diameter of the spray bore 52 can be maintained without affecting the foggy effect of the fluid. In addition, the lifetime of the product can be increased.

What is claimed is:

1. A fog nozzle with abrasion resistance, said fog nozzle assembled in a fog forming system, said fog nozzle comprising:
a nozzle body having a fluid throughway provided therein, said fluid throughway having two ends, one end defined as an entry, while the other end defined as an exit;
an embedded inner chamber formed at one end of said fluid throughway adjacent to said exit, said embedded inner chamber extended from said exit into said nozzle body;
a pusher assembled inside said fluid throughway, said pusher capable of moving freely inside said fluid throughway;
an abrasion resistant blockage assembled in said embedded inner chamber, a spray bore opened in an axial direction of said abrasion resistant blockage connecting to said fluid throughway;
thereby when fluid entering said nozzle body pushing said pusher, said fluid sprayed out from said spray bore of said abrasion resistant blockage forming fog, the high abrasion resistance of said abrasion resistant blockage reducing the abrasion of said spray bore, preventing the diameter of said spray bore to become large easily, and thus increasing the lifetime of said fog nozzle.

2. The fog nozzle with abrasion resistance according to claim 1, wherein said abrasion resistant blockage is made of ceramics.

3. The fog nozzle with abrasion resistance according to claim 1, wherein said abrasion resistant blockage is made of glass.

4. The fog nozzle with abrasion resistance according to claim 1, wherein said abrasion resistant blockage is made of tungsten steel.

5. The fog nozzle with abrasion resistance according to claim 1, wherein said abrasion resistant blockage is made of artificial gem.
